(19) United States
(12) Patent Application Publication
(10) Pub. No.: US 2022/0366435 A1
(43) Pub. Date: Nov. 17, 2022

(54) QUICK CAPTIONING IMAGE MARKETING IMAGES

(71) Applicant: QuikCaption, LLC, Daytona Beach Shores, FL (US)

(72) Inventors: Barry D. Boatner, Daytona Beach Shores, FL (US); Jason Wayne Bosarge, South Jordan, UT (US)

(21) Appl. No.: 17/741,276

(22) Filed: May 10, 2022

Related U.S. Application Data
(60) Provisional application No. 63/187,341, filed on May 11, 2021.

(51) Int. Cl. G06Q 30/02; G06V 20/60; G06T 11/60

(52) U.S. Cl. CPC G06Q 30/0201; G06V 20/60; G06T 11/60; G06Q 30/0206; G06T 2200/24

(57) ABSTRACT

Creating an image marketing image. The method includes obtaining an image of an item. The method further includes obtaining information about the item. The method further includes automatically creating a banner containing text derived from the information about the item. The method further includes automatically superimposing the banner on the image of the item to create an image marketing image.

### CROSS-REFERENCE TO RELATED APPLICATIONS

This application claims the benefit of and priority to U.S. Provisional Patent Application Ser. No. 63/187,341 filed on May 11, 2021 and entitled “Quickly Captioning Image Marketing Images,” and which application is expressly incorporated herein by reference in its entirety.

### BACKGROUND

### Background and Relevant Art

Image marketing involves the idea of combining images of products with textual information in a composite image describing various important features of the products. For example, image marketing may involve an image of an automobile along with an appropriately placed banner describing particularly marketable features of the automobile. For example, the banner may tout “low miles”, model year, upgraded features, particularly aggressive pricing, etc.

However, the process of creating images for image marketing, including overlaying banners on top of images of products, can be particularly labor-intensive involving specialized graphic designers and specialized software on computer systems to create the image marketing images. In particular, a graphic designer will need to obtain a product image. Then separately, the graphic designer creates a banner for overlaying on the product image. Finally, the designer will need to create a composite image, i.e. the image marketing image, which includes both the banner and the product image combined into a single image. This can be particularly labor-intensive and time-consuming when time is of the essence. For example, a busy car dealership may take in multiple vehicles for sale on a given day and creating image marketing images for each of the automobiles in this fashion may delay the ability to effectively market the vehicles using image marketing.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment illustrated herein includes a method of creating an image marketing image. The method includes obtaining an image of an item. The method further includes obtaining information about the item. The method further includes automatically creating a banner containing text derived from the information about the item. The method further includes automatically superimposing the banner on the image of the item to create an image marketing image.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1A illustrates a device acquiring an image of a product;

FIG. 1B illustrates functionality for the device obtaining information about the product and superimposing a banner on the image of the product to create an image marketing image;

FIG. 2 illustrates adding a custom banner to the image marketing image;

FIG. 3 illustrates elements for acquiring information about the product;

FIG. 4 illustrates elements for processing information to produce text for the banner; and

FIG. 5 illustrates a method of creating an image marketing image.

### DETAILED DESCRIPTION

Embodiments illustrated herein are directed to an automated device which is able to acquire images of items (such as products), identify features of those items, and then automatically create an image marketing image from the acquired images and the identified features. In this way, image marketing images can be created very quickly and efficiently. Additional details are now illustrated.

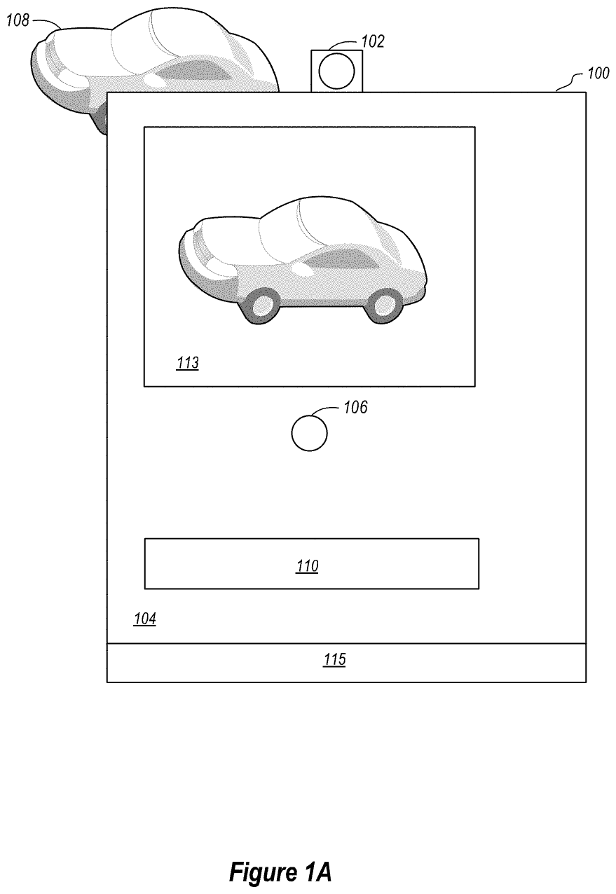

Referring now to FIG. 1A, an example is illustrated. FIG. 1 illustrates a device 100, which may be a computing device, that is configured to obtain images (such as image 113) of a product 108, although other items may have images obtained, such that when ‘product’ is used herein, it should be understood as a specific example of an item. The device 100 obtains information about the product 108. The device 100 is further configured to automatically create a banner containing text derived from the information about the product 108. The device 100 is further configured to automatically superimpose the banner on the image of the product to create an image marketing image.

For example, the device 100 includes an image capture device 102, which in this example is simply a camera. For example, the device 100 may be a cellular telephone, tablet, or other portable computing device having an integrated camera. This integrated camera can be used as the image capture device 102. The device 100 includes a user interface 104 including a user interface element 106 that allows the user to activate the image capture device 102 to acquire the image 113 of the product 108. In this example, the product 108 is an automobile. Further, in this example, the user interface element 106 is a shutter button displayed on the screen of the device 100. By the user selecting the element 106, the image capture device 102 will acquire an image 113 of the product 108 and display the image 113 of the product 108.

The device 100 further includes an information input interface 110 used to obtain information about the product 108. For example, the input interface 110 may be a text entry user interface such as an on-screen keyboard, external keyboard, or other input interface. Alternatively or additionally, the information input interface 110 may include a microphone and specialized computing processors (e.g., processor configured to use hardware processors, such as processor 115) configured to convert voice information to text information where the text information can be information about the product 108.

The device 100 further includes functionality for using information input at the information input interface 110 to create text which is then included in a banner 112 (see FIG. 1B) which is overlaid on the image 113 of the product 108 to create an image marketing image 114, where the image marketing image 114 is a composite of the banner 112 overlaid on the image 113 of the product 108. The created text is not necessarily the same information received at the information input interface 110. Rather, in some embodiments, the created text may be information derived from information received at the information input interface 110. For example, the information input interface 110 may receive information for a product 108, which in this example is a car, that the car has 46,000 miles on the odometer of the car. Based on expert system processing, machine learning processing, or other processing, at one or more computer processors, such as the hardware processor 115 at the device 100, a determination may be made that this represents “low miles” for the particular product. Thus, the text “Low Miles!!” for the banner 112 may be generated as a result.

Note that the banner 112 is typically an opaque banner that when placed directly over portions of the image 113 will block the ability to view those portions of the image 113. Note that in some embodiments, the banner 112 may be stitched above, below, or to one or more of the sides of the image 113 rather than obscuring existing portions of the image 113.

As illustrated in FIG. 1B, the device 100 displays on the user interface 104 various banner placement elements 116 that allow the user to manually override the automatic placement of the banner 112. For example, a user can select a banner placement element to cause the banner to be placed at the top of the image marketing image 114, diagonally across the top right-hand side of the image marketing image 114, diagonally across the top left-hand side of the image marketing image 114, at the bottom of the image marketing image 114, at the bottom right diagonally across the bottom right of the image marketing image 114, diagonally across the bottom left-hand side of the image marketing image 114, etc.

Note that in some embodiments, banner placement will be automatically selected based on the text identified for use in the banner 112. For example, number of characters, text size, or other text features may be used to determine automatic placement. For example, considering a traditional landscape image, if text above a predetermined threshold in size and/or number of characters is desired, a banner across the top of the image marketing image 114 may be automatically selected as opposed to a banner down the side of the image marketing image 114 or in a diagonal banner. However, if text below a predetermined threshold in terms of size and/or number of characters is identified for text for the banner 112, then a banner placement may be automatically selected for a more aesthetically pleasing placement such as if the banner 112 is placed in a diagonal across a corner of the image marketing image 114. As illustrated above, in some embodiments, the user may be nonetheless able to override this automatic placement by selecting one of the banner placement elements 116.

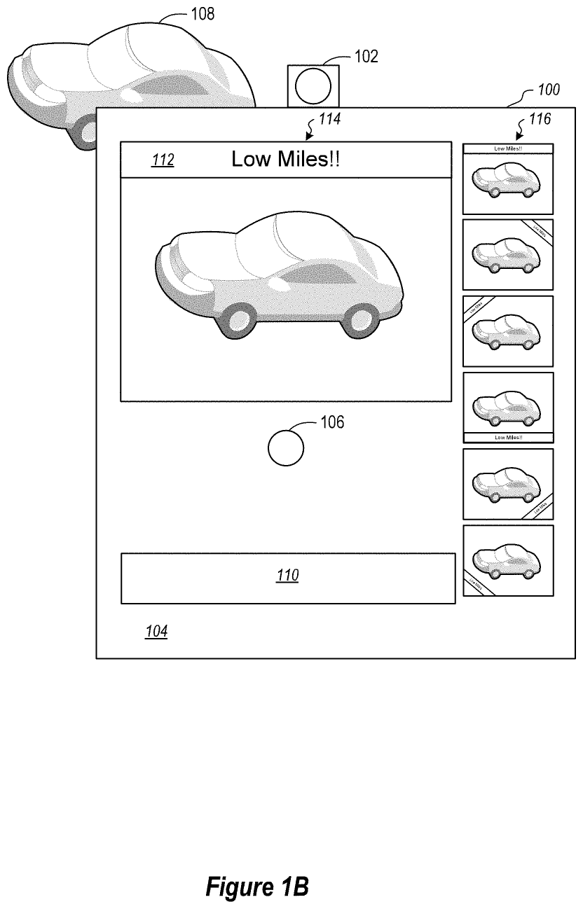

Often in image marketing scenarios, there is a desire to add additional banners that are independent of the product itself. For example, there may be a desire to add a banner to the image marketing image 114 that proclaims the sale of the product is part of a holiday sale or other special event. That is, information that is not particularly dependent on the nature of the product 108 itself may nonetheless be useful in accomplishing a successful image marketing campaign. Thus, attention is directed to FIG. 2 which illustrates a custom banner selection element 118 included in the user interface 104. The custom banner selection element 118 allows a user to add a custom banner 120 in addition to the banner 112 (or alternatively without the banner 112) to the image marketing image 114. Various features and functionality may be implemented into the custom banner selection element 118. For example, in some embodiments, a custom banner selection process executed by processors (such as hardware processor 115) included in the device 100 may automatically identify custom banners to provide to the user through the custom banner selection element 118. For example, the custom banner process may execute instructions to automatically identify a number of pre-made banners based on characteristics of the banners. For example, the custom banner process may identify banners by using a current date as input to identify or automatically create banners that have information in the custom banners that corresponds to the current date, such as holiday sales anniversary sales and the like.

Thus, for example, the device 100 may include a database having premade banners, region specific information, country specific information, company specific information, etc. The information in the database may be used to create banners as appropriate. For example, region specific information and country specific information may include information about holidays or other events. If a current date is the same or temporally proximate a holiday or other event, the device may include processes to identify corresponding premade banners or to automatically generate relevant banners. For example, the name of the holiday, plus the word “Sale” may be used to generate a banner. Holiday relevant colors (e.g., red, white and blue for 4th of July or green and red for Christmas), holiday relevant fonts and styles, etc. may be used to automatically generate banners. With respect to company information stored in the database, banners may be automatically created for anniversary sales, half yearly sales based on past practices, or other events that are traditionally and historically used by the company in sales and/or promotions.

The custom banner selection element 118 may be implemented in a number of different fashions. For example, in some embodiments the custom banner selection element 118 can be implemented as a cycling toggle element where a user is able to cycle through custom banners identified by the custom banner process. For example, a user can tap sequentially the custom banner selection element 118 causing a display on both a thumbnail image of the custom banner selection element 118 as well as on the main image of the image marketing image 114 the effects of applying a currently selected custom banner. This allows for a minimization of real estate space on the user interface 104 with respect to the custom banner selection element 118. However, in other embodiments, custom banner selection elements similar to the banner placement elements 116 may be implemented where a plurality of thumbnails are presented to the user allowing the user to select one of the elements in the plurality of selection elements to cause application of the custom banner 120 to the image marketing image 114.

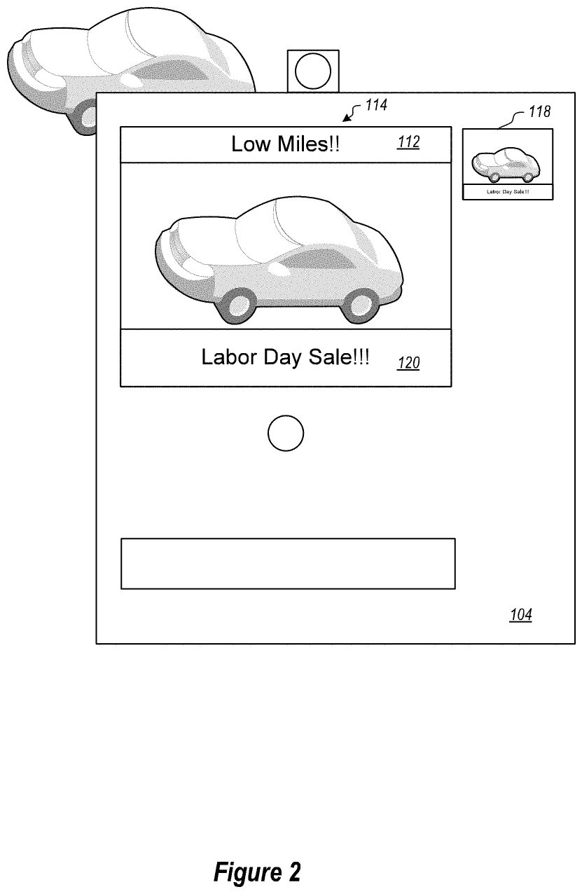

Returning once again to the discussion of deriving text for the banner 112, additional information is now illustrated. In the example illustrated in FIG. 1A, it was shown that information could be input into the information input interface 110 using text input and/or voice input. However, it should be appreciated that information input into the information input interface can come from one or more of a number of different sources. For example, attention is directed to FIG. 3 which illustrates the information input interface 110 coupled to a plurality of data sources 122. Note that the information input interface 110 may be coupled to any one of the information sources 122 or combinations of the information sources 122.

FIG. 3 illustrates in one example voice input 122-1. The voice input 122-1 is similar or identical to the voice input described previously in conjunction with FIG. 1A.

FIG. 3 further illustrates text input 122-2. The text input 122-2 is similar to the text input described above in conjunction with FIG. 1A.

FIG. 3 further illustrates a lifetime tracking service input 122-3 which tracks events over all or a portion of the lifetime of an item. For example, embodiments may receive information about specific products. This information may be specific to a particular example product. For example, in the automobile industry, services exist which track particular automobiles including tracking mileage, maintenance history, sales history, accidents, accessory add-ons, etc. The device 100 may be able to connect to one of these services via a network connection or other appropriate connection to obtain data regarding specific vehicles. Thus, in some embodiments, information identifying the product 108 can be provided from the device 100 to the lifetime tracking service 122-3, through the information input interface 110 which can in response provide particular information about a product itself. For example, this may be provided by providing a serial number such as in the automobile industry the VIN number, a license plate number, or other serial number type identifier to the lifetime tracking service 122-3. In some embodiments, the device 100 may use the image capture device 102 and text recognition or other functionality to identify the serial number and to automatically communicate the serial number to the lifetime tracking service 122-3, such as through cellular data services, or other network data services.

FIG. 3 further illustrates a product database 122-4 which can provide input to the information input interface 110. The product database 122-4 may include for example a database that stores information about particular individual products or products based on a product model number. For example, the serial number, VIN number, model number, or other identifier may provide information describing characteristics such as accessories, included components, options, and so forth. Thus, in a fashion similar to that discussed previously with respect to the lifetime tracking service 122-3, serial numbers, model numbers, and the like may be provided to the product database 122-4 which can then provide particular information about the product 108 to the information input interface 110.

FIG. 3 further illustrates an image analysis of image information source 122-5. For example, some embodiments may include artificial intelligence image analysis tools that are able to analyze images such as the image 113 or other images of the product 108 to attempt to identify characteristics of the product 108. For example, in some embodiments, the image analysis may be able to read make and/or model information from images, identify accessories appearing in an image, identify wear and tear on a product, etc. For example, the image analysis can identify the installation of certain accessories such as lighting, exhaust systems, body modifications, etc. Image analysis may be able to identify damage. Image analysis may be able to identify tread wear on tires. The image analysis information source may be an external computing system that is able to perform the intensive artificial intelligence computing needed to identify such information, or may be even an image analysis tool included on the device 100 itself that is capable of identifying limited amounts of information from the image analysis of an image.

Note that as discussed above, embodiments may use any or all of the information sources 122 to obtain information about the product 108 to create the text for the banner 112. As can be imagined, there is the possibility that large amounts of information can be obtained such that too much information exists for a simple banner on an image marketing image 114. Thus, some embodiments may include functionality for identifying particularly relevant or desired information for the banner 112.

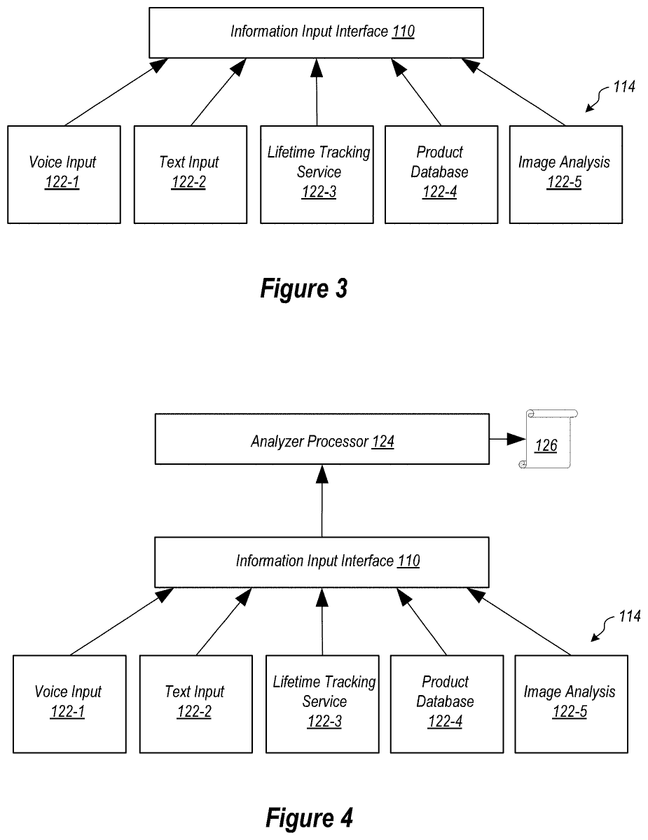

Attention is now directed to FIG. 4 to illustrate this functionality. FIG. 4 once again illustrates the information input interface 110. The information input interface 110 is coupled to an analyzer processor 124. The analyzer processor 124 may be included as part of the device 100 or may be included in an external service which is able to be communicated with by the device 100 through cellular data connections or other network connections. The analyzer processor 124 assembles the various pieces of information about the product 108 and analyzes the information to produce particular text 126 from the information for the banner 112. Selection of the text 126 may be accomplished in a number of different fashions. For example, in some embodiments, the analyzer processor 124 may have trained models that are able to consume the information and to generate from information, the text 126 that is identified to have a potential to produce an optimized result, such as a higher sale price. Alternatively, text 126 can be identified that has a potential to produce a faster sale than other text. Alternatively or additionally, text 126 can be identified that has a potential to increase interest by a particular demographic. Thus, the analyzer processor 124 can be used to identify text 126 based on characteristics of the product 108 that is intended to produce a particular marketing result. As noted previously, this can be accomplished by using trained models or other artificial intelligence functionality implemented by the analyzer processor 124.

Once the image marketing image 114 is created, it can be stored or shared in a variety of different fashions. For example, in some embodiments, the image marketing image 114 may simply be stored in a gallery application of the device 100. Alternatively, or additionally, the device 100 may be coupled to network hardware which allows the device to transfer the image marketing image 114 to a remote server or other system where the image marketing image 114 can be added to a marketing campaign. Alternatively, or additionally, the device 100 may include an application for marketing functionality which allows the image marketing image 114 to be directly imported into an appropriate marketing campaign.

Note that the image marketing image 114 can be stored and/or transferred in a number of different formats such as JPEG, Gif, raw, bitmap, or even as combinations of elements which can be grouped into a single digital object. Indeed, in some embodiments, additional information can be added as metadata to the digital object, such as voice notes, GPS coordinates for the product or for an entity selling the product, additional textual information about a product such as product details or specifics, salesman contact information, URLs or other digital pointers to the product, etc.

Further, the image marketing image 114 can be an image include in a video. Thus, in the examples illustrated above, while one might imagine a single image being implemented, it should be appreciated that multiple sequentially displayed images included as a video file may be implemented in some embodiments. Thus, the various banners illustrated above may be superimposed over parts or entireties of videos. Thus, references to images herein contemplate that often those images will be part of a video project.

While the examples illustrated above have been illustrated in the context of a product 108 being photographed and information being input into the information interface input 110, alternative embodiments may allow for other functionality to be implemented. For example, in some embodiments, instead of a product being photographed, some embodiments can photograph other objects including people, locations, animals, or virtually anything that is capable of being photographed.

In some embodiments, the information input into the information input interface 110 may further include other types of information. For example, in some embodiments location can be input into the information input interface 110. That is, in some embodiments a type of geo-fence functionality may be implemented. In some embodiments this can be accomplished by using GPS, Wi-Fi location hardware, network IP addresses, cellular tower triangulation, or other input which can accurately identify the location of the object being photographed. In another example, the user may be able to scan a barcode or other identifier using the image capture device 102 where the barcode or other identifier is placed in a particular location. This barcode can identify the location to the device 100 so as to be able to add certain location information to the banner 112.

Thus, in some embodiments, the banner 112 may be placed on an image similar to the image marketing image 114 with information relevant to the location information received at the information input interface. For example, if a picture were taken of a user at a national park, such as Yellowstone National Park at Old Faithful Geyser, a banner 112 may be added to the image 114 that identifies information such as the location, date, and any other relevant information.

In some embodiments, a database may be maintained either locally at the device 100 or at a remote server which the device 100 can contact to obtain custom banners for various custom locations. For example, artwork particular to Yellowstone Old Faithful geyser can be provided to the device 100 and can be selected by a user for addition to the image 114 in the banner 112 or the custom banner 120. In some embodiments, multiple different banner options for a particular location can be provided. The different options can be selected such as by using functionality similar to the custom banner selection element 118, or using functionality similar to the banner placement elements 116 but where the different options are different artistic options rather than different placement options.

Note that in some embodiments, the information input interface 110 may further include information identifying the subject of the photograph 113, such as names of the individuals photographed in the image 113 or other identifying information. In some such embodiments, the banner 112 may also include text describing the individuals in the image 113.

Further note that some embodiments may be used for real estate applications where location information can be used to add real estate information to banners, such as information touting a neighborhood, location, price based on location, etc.

Further note that some embodiments may add logos or other such images based on location information. The logos may be based on recognition that the picture was taken near an enterprise or other entity having an associated logo.

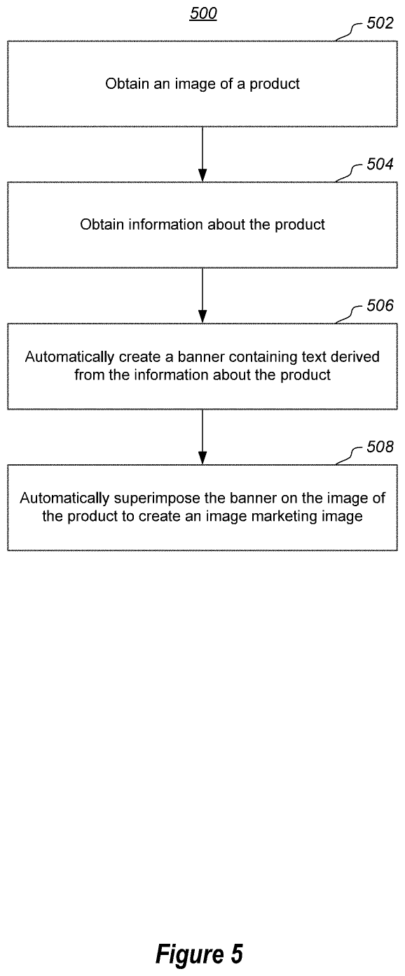

Referring now to FIG. 5, a method 500 is illustrated. The method 500 includes acts for creating an image marketing image. The method 500 includes obtaining an image of an item (act 502).

The method 500 further includes obtaining information about the item (act 504).

The method 500 further includes automatically creating a banner containing text derived from the information about the item (act 506).

The method 500 further includes automatically superimposing the banner on the image of the item to create an image marketing image (act 508).

In some embodiments, the method 500 may be practiced where obtaining an image of an item comprises obtaining the image using a camera device coupled to a computing device configured to perform the acts of the method.

In some embodiments, the method 500 may be practiced where obtaining information about the item comprises receiving user input in the form of voice input describing the item.

In some embodiments, the method 500 may be practiced where obtaining information about the item comprises receiving user input in the form of text input describing the item.

In some embodiments, the method 500 may be practiced where obtaining information about the item comprises using a unique code (e.g., VIN, serial number, specialized model number, etc.) associated with the item to obtain the information about the item from a database correlating the unique code with the information about the item.

In some embodiments, the method 500 may be practiced where obtaining information about the item comprises obtaining information from a service that has tracked the life of the item.

In some embodiments, the method 500 may be practiced where obtaining information about the item comprises performing artificial intelligence analysis of the image of the item to identify the information about the item.

In some embodiments, the method 500 may be practiced where obtaining information about the item comprises obtaining information about the item from multiple sources and identifying prioritized information that is used to create the text derived from the information about the item.

In some embodiments, the method 500 may be practiced where identifying prioritized information comprises performing artificial intelligence analysis of the information from multiple sources to identify information that is identified as having a potential to produce at least 1 of a higher sale price, a faster sale, increased interest by a particular demographic.

In some embodiments, the method 500 may be practiced where the text derived from the information about the item comprises a sales price automatically created by automated analysis of the information about the item. For example, knowing information about the condition of the item, accessories included on the item, and other information about the item, analysis may be automatically performed, such as by using artificial intelligence, to identify an appropriate asking price for the item.

In some embodiments, the method 500 may further include automatically determining banner placement based on the characteristics of the text derived from the information about the item.

In some embodiments, the method 500 may further include providing a plurality of banner placement options to a user in a user interface to allow the user to select banner placement.

In some embodiments, the method 500 may further include providing a user interface element allowing a user to select a custom banner to be superimposed on the image, the custom banner containing information independent of the item.

Further, the methods may be practiced by a computer system including one or more processors and computer-readable media such as computer memory. In particular, the computer memory may store computer-executable instructions that when executed by one or more processors cause various functions to be performed, such as the acts recited in the embodiments. In some embodiments, processors may include hardware elements as well as firmware and/or software elements executing on the hardware elements.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer-readable storage media and transmission computer-readable media.

Physical computer-readable storage media includes RAM, ROM, EEPROM, CD-ROM or other optical disk storage (such as CDs, DVDs, etc.), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

The present invention may be embodied in other specific forms without departing from its characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A portable computing device for creating an image marketing image, the portable computing device comprising:
an image capture device;
a user interface comprising a user interface element configured to allow a user to capture an image of an item using the image capture device;
an Information input interface configured to capture information about the item; and
one or more processors coupled to the information input interface, wherein the one or more processors are configured to:
derive text from the information captured about the item;
automatically creating a banner containing the text derived from the information about the item; and
automatically superimposing the banner on the image of the item to create an image marketing image.

2. The portable computing device of claim 1, wherein the Information input interface is configured to capture voice input describing the item.

3. The portable computing device of claim 1, wherein the Information input interface is configured to obtain the information from a lifetime tracking service, tracking events over a lifetime of the item.

4. The portable computing device of claim 1, wherein the Information input interface is configured to obtain the information from image analysis of the item.

5. The portable computing device of claim 1, wherein the Information input interface is configured to obtain the information from a product database for the item.

6. The portable computing device of claim 1 further comprising an analyzer processor configured to use the information to produce text to optimize sales time or price.

7. A method of creating an image marketing image, the method comprising:
obtaining an image of an item;
obtaining information about the item;
automatically creating a banner containing text derived from the information about the item; and
automatically superimposing the banner on the image of the item to create an image marketing image.

8. The method of claim 7, wherein obtaining an image of an item comprises obtaining the image using a camera device coupled to a computing device configured to perform the acts of the method.

9. The method of claim 7, wherein obtaining information about the item comprises receiving user input in the form of voice input describing the item.

10. The method of claim 7, wherein obtaining information about the item comprises receiving user input in the form of text input describing the item.

11. The method of claim 7, wherein obtaining information about the item comprises using a unique code associated with the item to obtain the information about the item from a database correlating the unique code with the information about the item.

12. The method of claim 7, wherein obtaining information about the item comprises obtaining information from a service that has tracked the life of the item.

13. The method of claim 7, wherein obtaining information about the item comprises performing artificial intelligence analysis of the image of the item to identify the information about the item.

14. The method of claim 7, wherein obtaining information about the item comprises obtaining information about the item from multiple sources and identifying prioritized information that is used to create the text derived from the information about the item.

15. The method of claim 14, wherein identifying prioritized information comprises performing artificial intelligence analysis of the information from multiple sources to identify information that is identified as having a potential to produce at least one of a higher sale price, a faster sale, increased interest by a particular demographic.

16. The method of claim 7, wherein the text derived from the information about the item comprises a sales price automatically created by automated analysis of the information about the item.

17. The method of claim 7, further comprising automatically determining banner placement based on the characteristics of the text derived from the information about the item.

18. The method of claim 7, further comprising providing a plurality of banner placement options to a user in a user interface to allow the user to select banner placement.

19. The method of claim 7, further comprising providing a user interface element allowing a user to select a custom banner to be superimposed on the image, the custom banner containing information independent of the item.

20. A computer-readable medium comprising computer executable instructions that when executed by one or more processors causes the one or more processors to perform the following acts for creating an image marketing image:
obtaining an image of an item;
obtaining information about the item;
automatically creating a banner containing text derived from the information about the item; and
automatically superimposing the banner on the image of the item to create an image marketing image.
